(19) United States
(12) Patent Application Publication
(10) Pub. No.: US 2008/0233902 A1
(43) Pub. Date: Sep. 25, 2008

(54) METHOD AND APPARATUS FOR COMMUNICATING PRECODING OR BEAMFORMING INFORMATION TO USERS IN MIMO WIRELESS COMMUNICATION SYSTEMS

(75) Inventors: Kyle Jung-Lin Pan, Smithtown, NY (US); Donald M. Grieco, Manhasset, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 12/053,186

(22) Filed: Mar. 21, 2008

Related U.S. Application Data
(60) Provisional application No. 60/896,157, filed on Mar. 21, 2007.

(51) Int. Cl. H04B 1/04

(52) U.S. Cl. 455/114.3; 375/296

(57) ABSTRACT

Methods and apparatus for communicating precoding or beamforming information to users are disclosed. A feedback signal including a reported preceding matrix index (PMI) is received and a determination made as to the state of the feedback. Precoding rules associated with the determined state are then used to select a precoding matrix. The state information is transmitted to a wireless transmit receive unit (WTRU), which uses the state information and the precoding rules associated therewith to select the precoding matrix used to precoded a received precoded data signal.

### CROSS REFERENCE TO RELATED APPLICATIONS

This application claims the benefit of U.S. provisional application No. 60/896,157, filed Mar. 21, 2007, which is incorporated by reference as if fully set forth.

### FIELD OF INVENTION

The present invention is related to a wireless communication network.

### BACKGROUND

Third Generation Partnership Project (3GPP) and 3GPP2 are considering long term evolution (LTE) for radio interface and network architecture. Currently, receivers use a common reference signal for channel estimation, decide the precoding matrix based on the estimated common channel and feedback the information about the precoding matrix to the transmitter. The transmitter then uses the fed back precoding matrix and multiplies it with the data signal to be transmitted. Due to the feedback error the precoding matrix used by the transmitter may be different from the precoding matrix signaled from receiver. Also due to network flexibility, the transmitter may decide to use a different precoding matrix than the one that is signaled from the receiver even if there is no feedback error. Therefore a precoding or beamforming information or preceding matrix index (PMI) is signaled to the receiver. The receiver decodes the control channel to obtain the precoding information and uses this precoding information to demodulate the precoded data signal.

It has been shown that channel mismatch between transmitting and receiving due to MIMO precoding or beamforming results in BER/BLER floor, which sometimes can be significant. Signaling the entire precoding information from transmitter to receiver or performing PMI validation at the receiver are used to avoid channel mismatch between transmitting and receiving due to precoding or beamforming. Currently, signaling precoding information from transmitter to receiver uses a control channel and has very high signaling overhead. This is especially true in a frequency selective channel environment in which there may be multiple sub-bands (N sub-bands) for the entire bandwidth and thus multiple precoding matrices (N precoding matrices) each of which corresponds to a sub-band in frequency to be signaled. By way of background, a sub-band is a group of subcarriers.

Performing PMI validation at a receiver is another way to obtain the precoding or beamforming information. However it requires blind detection for all possible precoding or beamforming matrices, which requires high overhead and complexity. Further, performing PMI validation at the receiver requires a transmitter to send a dedicated reference signal, with precoding information embedded in the reference signal which increases system overhead.

Accordingly, there exists a need for an improved method of reducing the signaling overhead for signaling preceding information from transmitter to receiver and reducing the detection complexity for PMI validation and improving PMI detection performance.

### SUMMARY

Methods and apparatus for communicating precoding or beamforming information to users are disclosed. A feedback signal including a reported precoding matrix index (PMI) is received and a determination made as to the state of the feedback. Precoding rules associated with the determined state are then used to select a precoding matrix. The state information is transmitted to a wireless transmit receive unit (WTRU), which uses the state information and the precoding rules associated therewith to select the precoding matrix used to precoded a received precoded data signal.

### BRIEF DESCRIPTION OF THE DRAWINGS

A more detailed understanding of the invention may be had from the following description of a preferred embodiment, given by way of example and to be understood in conjunction with the accompanying drawing(s) wherein:

FIG. 1 shows an example block diagram of a wireless communication system;

FIG. 2 shows an example block diagram of a transmitter and receiver configured to implement a disclosed precoding information communication or validation method;

FIG. 3 is flow diagram of the disclosed PMI validation method;

FIG. 4 is a flow diagram of an alternative PMI validation method.

FIG. 5 illustrates the disclosed precoding information communication method in accordance with a preferred embodiment of the present invention; and

FIG. 6 is another example of the disclosed preceding information validation method illustrated in FIG. 3.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B (eNB), a site controller, an access point (AP), or any other type of interfacing device capable of operating in a wireless environment.

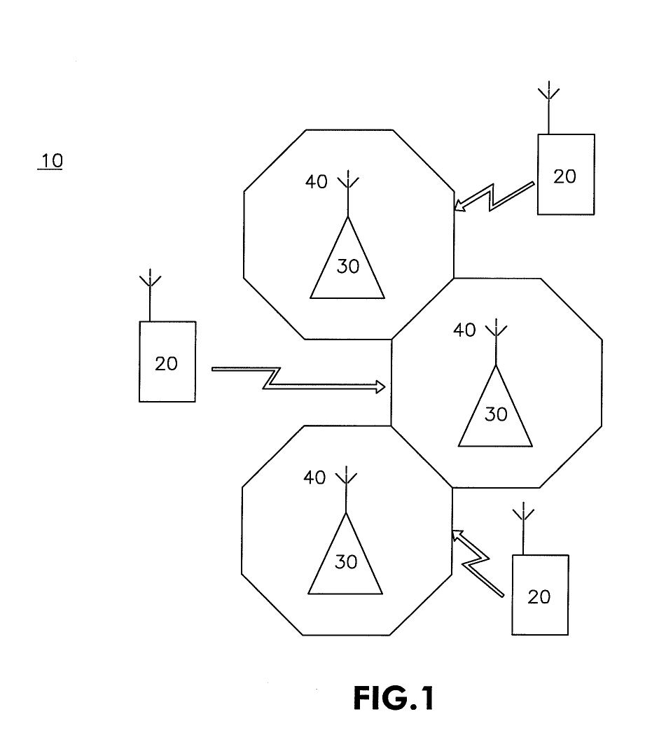

Referring to FIG. 1, an LTE wireless communication network (NW) 10 comprises one or more WTRUs 20, one or more eNBs 30, and one or more cells 40. Each cell 40 comprises one or more eNBs (NB or eNB) 30.

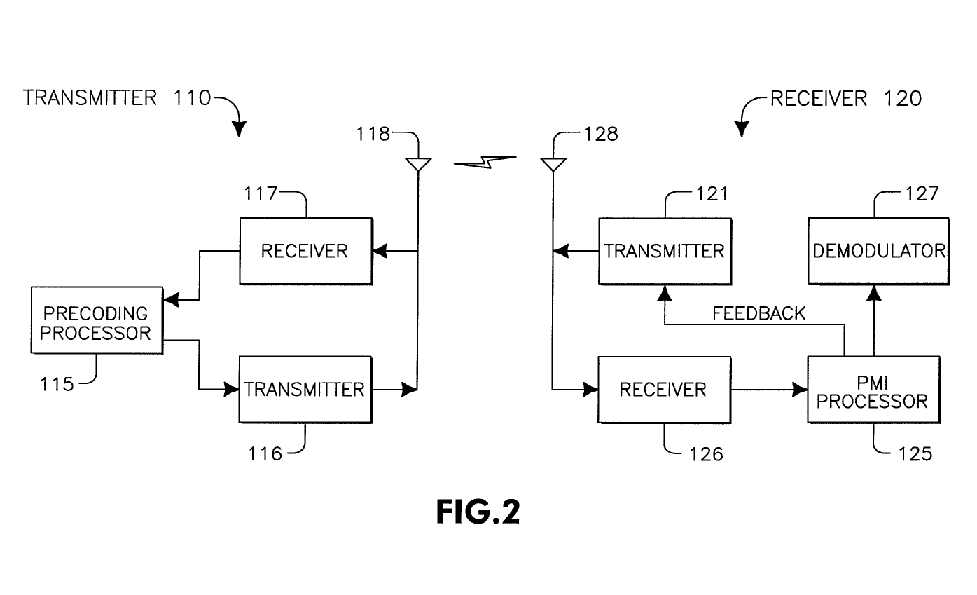

FIG. 2 is a functional block diagram of a transmitter 110 and receiver 120 configured to perform a disclosed method of precoding matrix (PMI) validation. In addition to components included in a typical transmitter/receiver, transmitter 110 comprises a precoding processor 115, a receiver 117, a transmitter 116, and an antenna array 118. Precoding processor 115, coupled to receiver 117 and transmitter 116, determines a precoding matrix to be used by transmitter 110 when transmitting a data transmission, for example, orthogonal frequency division multiplexing (OFDM) symbols, to a receiver 120. Precoding processor 115 also precodes the data symbols.

Receiver 120 comprises a receiver 126, a transmitter 121, a PMI processor 125 and a demodulator 127. As disclosed in greater detail hereinafter, receiver 120 comprising receiver 126, receives a transmitted data block from eNB 30, performs channel estimation, calculates an effective channel estimate and demodulates the received data symbols using the effective channel estimation. In accordance with this disclosed method, included in the received data block is a PMI signal from transmitter 110 indicating which precoding matrix was used by transmitter 110 to precode the data block.

For purposes of this disclosure, eNB 30 comprises transmitter 110, and WTRU 20 comprises receiver 120. It should be noted though that transmitter 110 may be located at a WTRU or at a base station, and receiver 120 may be located at either the WTRU, base station, or both.

A channel estimate is conducted by PMI processor 125 and a precoding matrix or vector, determined using the channel information, is obtained from received common reference signals within the received data symbols, such as a common pilot signal. The precoding matrix or vector is selected using a codebook, for example, wherein PMI processor 125 selects an index associated with the optimum precoding matrix or vector, a precoding matrix indicator (PMI). A feedback signal, including the PMI, is transmitted to eNB 30, including transmitter 110.

As those having skill in the art know, the common reference signal is cell specific for all WTRUs within the cell receiving a signal transmitted from eNB 30. It should be noted that although the term precoding matrix is used throughout this disclosure, the receiver and transmitter may select and use a precoding vector or beamforming matrix or vector in the same manner.

A method is disclosed wherein the condition of a feedback signal is determined and categorized into one or more states, each of which indicates a particular condition of the feedback signal. In accordance with this disclosed method, a precoding rule, or set of preceding rules, is associated with each state. An example precoding rule set is shown in Table 1 below.

TABLE 1

| | Feedback | PMI used for precoding |
|---|---|---|
| State | Error | matrix |
| 0 | No | PMI selected by WTRU |
| 1 | Yes | PMI associated with |
| | | previously used precoding |
| | | matrix |
| 2 | Yes | PMI associated with a |
| | | default precoding matrix |
| 3 | reserved | reserved |

As shown in the example precoding rule in Table 1, state 0 indicates that a feedback error has not been detected in the feedback signal or the feedback signal is reliable; state 1 and 2 indicates that an error was detected in the feedback signal or the feedback signal is not reliable, including a measurement of the signal quality was too low; state 3 is reserved. It should be noted that although four states (4) states are shown in this table, more or less states may be used depending on the design of system 10.

Also shown in Table 1 are example precoding rules that are associated with each state. For example, the precoding rules are as follows”

if state 0 is detected, then a reported PMI is used;

if state 1 is detected, then a previously used precoding matrix is used; and

if state 2 is detected, then a default matrix or matrices is used.

Details regarding these states are discussed in greater detail below. It should be noted, though, that any predefined precoding rule can be associated with any state, and multiple states can be associated with a single preceding rule. It should also be noted that the precoding rule set that is being used is known by eNB 30 and WTRU 20

Referring back to FIG. 2, and in accordance with the disclosed method, once eNB 30 receives the feedback signal, including the reported PMI, receiver 115 forwards the feedback signal to precoding processor 115. Precoding processor 115, therefore, receives the feedback signal and determines the state of the feedback signal. As those skilled in the art should know, the condition of this signal can be determined using any known error checking algorithm, such as cyclic redundancy checking (CRC), using a parity bit, measurement of the signal quality or the equivalent. The reliability of this signal may also be conducted using any method of making this determination. Using any of the available methods for error checking and determining the reliability of the signal, preceding processor 125 determines the state of the feedback signal.

As indicated above, each possible state of the feedback signal has an associated precoding rule, which are predetermined by system 10 and signaled to eNB 30 and WTRU 20. As such, upon determination of the state of the feedback signal, precoding processor 115 selects the appropriate precoding rule associated with the detected state. Using the example shown in Table 1 above, if precoding processor 115 does not detect a feedback error, precoding processor 115 determines that the feedback signal is in state 0. Since the precoding rule associated with state 0 requires the use of the reported PMI, precoding processor 115 selects the preceding matrix associated with the reported PMI.

If precoding processor 115 detects a feedback error, precoding processor 115 selects the precoding matrix based on predefined rules. It is preferable that the rules regarding selection of the precoding matrix upon detection of a feedback error and/or feedback signal condition are known to eNB 30 and WTRU 20.

In accordance with the disclosed method, when precoding processor 115 determines that the feedback signal is in state 1, and therefore, detects a feedback error, precoding processor 115 selects the previously used preceding matrix, which is in accordance with the precoding rule associated with state 1.

If precoding processor 115 detects that the feedback error is unreliable, or that the feedback signal is unreliable, precoding processor 115 determines that the feedback signal is in state 2, and therefore selects the default matrix, as defined in the precoding rule associated with state 2. A default matrix may be any precoding matrix that is predefined and known as the default matrix by eNB 30 and WTRU 20. For example, the default matrix may be an identity matrix which indicates no precoding, or some fixed coefficient matrix.

It is preferable also that eNB 30 uses the default matrix for a change in radio bearer (RB) due to scheduling. Upon initialization, eNB 30 may use the default matrix or no precoding. It should be noted that the default matrices for initialization, change of radio bearer and upon detecting a feedback error may be different. For example, the default matrix for initialization may be identified as the default 1, for a RB change, default 2 may be identified, and the default matrix for the detection of a feedback error may be default 3. Therefore, default 1, default 2 and default 3 may be equal to one another or different. Although, each of these conditions are not related necessarily to the reported PMI from WTRU 20, WTRU 20 and eNB 30 are signaled each of these defaults within the precoding rules provided by system 10; or WTRU 20 is signaled each of these defaults within the precoding rules provided by eNB 30.

Once precoding processor 115 selects the appropriate precoding matrix, the data block to be transmitted is precoded using the selected precoding matrix, and forwarded to transmitter 116 for transmission. Precoding processor 115 also forwards the detected state of the feedback signal to transmitter 116 as a “feedback state” signal. Transmitter 116, preferably includes the “feedback state” signal in a control channel that is transmitted to WTRU 20.

The feedback state signal is an explicit and express signal transmitted by eNB 30 to WTRU 20 indicating the state of the feedback signal received at eNB 30. In accordance with this method, the feedback state signal may be carried in bits of the physical downlink control channel, or carried by other signaling. The feedback state signal may be 2-bits or more depending on the number of possible states used by system 10 and known to eNB 30 and WTRU 20. An example of a 2-bit feedback state signal is shown in Table 2.

TABLE 2
(Precoding Rule Set A)

| Two Bit feedback | | PMI used for precoding |
|---|---|---|
| state signal | State | matrix |
| 00 | 0 | reported PMI from WTRU |
| 01 | 1 | PMI associated with |
| | | previously used precoding |
| | | matrix |
| 10 | 2 | PMI associated with a |
| | | default precoding matrix |
| 11 | 3 | PMI associated with a |
| | | second default precoding |
| | | matrix |

An example table showing examples of how the state of the feedback signal can be defined are shown in FIG. 2A below. As indicated, a state can be defined by the reliability of the feedback signal, including whether an error was detected in the feedback signal. Another way in which the state can be defined is by whether eNB 30 overrides the reported PMI. In accordance with the example, in state 0 and 1, eNB 30 does not override the reported PMI, and in states 2 and 3, eNB 30 does override the reported PMI.

TABLE 2A

| | | | eNodeB | |
|---|---|---|---|---|
| Two Bit | | | override the | |
| feedback | | Feedback | WTRUs | PMI used for |
| state signal | State | error | feedback | precoding matrix |
| 00 | 0 | no | no | reported PMI from |
| | | | | WTRU |
| 01 | 1 | yes | no | PMI associated |
| | | | | with previously |
| | | | | used precoding |
| | | | | matrix |
| 10 | 2 | no | yes | PMI associated |
| | | | | with a default |
| | | | | precoding matrix |
| 11 | 3 | yes | yes | PMI associated |
| | | | | with a second |
| | | | | default precoding |
| | | | | matrix |

WTRU 20 receives the feedback state signal and the precoded data signal from eNB 30 at receiver 126. Receiver 126, coupled to PMI processor 125, forwards the precoded data signal and the feedback state signal to PMI processor 125. PMI processor 125 receives the feedback state signal within the control channel and decodes the control channel to extract the feedback state signal. Using the example shown in Table 2, when eNB 30 determined that the feedback signal was in state 0, PMI processor 125 detects a “00” in the two bits reserved for this signal. A “01” is detected by PMI processor 125 when eNB 30 determines that the feedback signal is in state 1. Accordingly, WTRU 20 is able to determine what state the feedback signal is in at eNB 30.

As indicated above, the precoding rules regarding which preceding matrix eNB 30 will use depending on the state of the feedback signal is known also by WTRU 20, and therefore used by PMI processor 125 to determine which PMI to use to select the precoding matrix for demodulation. As such, when PMI processor 125 determines the state of the feedback signal, it then selects the PMI associated with the detected state based on the precoding rules. For example if eNB 30 determined that the feedback signal was in state 1, a “01” would be detected by PMI processor 25, indicating state 1. PMI processor 125 then selects the preceding matrix using the PMI associated with the previously used precoding matrix, as required by the precoding rules. Using the selected PMI, PMI processor 125 forwards the associated precoding matrix to demodulator 127. Demodulator 127, coupled to PMI processor 125, demodulates the precoded data signal using the precoding matrix forwarded to it by PMI processor 125.

In the example shown in Table 2, a fourth state, state 3, having a feedback state signal of “11”, may be included in the predefined precoding rules. State 3 may indicate that eNB 30 has determined that although a feedback error was detected, the previously used preceding matrix associated with state 1 is not reliable. Therefore, as shown, eNB 30 is required to use a second default matrix for precoding. As such, PMI processor 125, upon detection of state 3, would select the precoding matrix associated with the PMI associated with the second default matrix.

Although Table 2 indicates a certain PMI to be used based on the feedback state signal, any PMI may be associated with any of the possible feedback state signals, since the feedback state signals are predefined and known to eNB 30 and WTRU 20 upon initialization. It should be noted, also, that although a 2-bit signal has been illustrated, again, any number of bits may be used for signaling the feedback state signal to indicate appropriate PMI to WTRU 20.

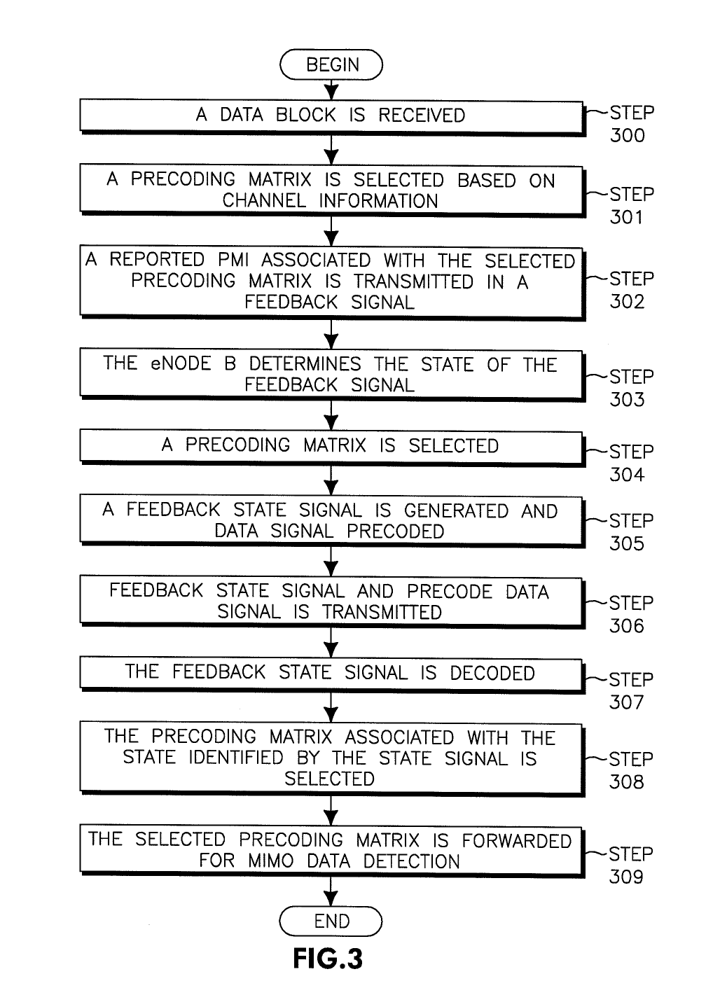

A flow diagram of the disclosed method is illustrated in FIG. 3. WTRU 20 receives a data signal from eNB 30 (step 300). PMI processor 125 of WTRU 20 selects a precoding matrix from a codebook based on the channel state information (step 301). A reported PMI associated with the selected precoding matrix is included in a feedback signal transmitted to eNB 30 (step 302).

Precoding processor 115 of eNB 30 determines the state of the feedback signal based on the reliability of the feedback signal, including determining whether there is a feedback error (step 303) and selects a preceding matrix based on the precoding rule associated with the determined state (step 304).

Once the precoding matrix is selected by precoding processor 115, the data symbols are precoded using the selected precoding matrix a feedback state signal generated (step 305). The feedback state signal and the precoded data symbols are transmitted to WTRU 20. (Step 306).

WTRU 20 receives the precoded data symbols and the control channel including the feedback state signal and forwards them to PMI processor 125. PMI processor 125 decodes the control channel and determines the feedback state signal (step 307). PMI processor 125, then, selects the precoding matrix associated with the PMI associated with the detected state using the precoding rules (step 308). The selected precoding matrix is used by WTRU 20 to demodulate the precoded data signal (step 309).

In accordance with an alternative method, instead of an explicit feedback state signal being transmitted, the precoding information associated with the state of the feedback signal is embedded in a reference signal. The reference signal is precoded using the precoding rules, or set of precoding rules, by eNB 30.

In accordance with this method, eNB 30 and WTRU 20 know the states, the precoding rules and the PMI's associated with each rule and state. As such, PMI processor of WTRU 20 performs PMI validation on each of the PMIs associated with each state and precoding rule included in the predefined precoding rules. For example, the precoding rules used in Table 2 indicate that the set of possible PMIs that were used by eNB 30 to precode the reference signal and data signal are the following: PMI1: the reported PMI, PMI2: the PMI associated with the previously used precoding matrix, PMI3: the PMI associated with the default matrix, and PMI4: the PMI associated with a second default matrix. In accordance with this example, PMI processor 125 performs PMI validation using the PMI for each of the PMIs in this set of PMIs (that is PMI1, PMI2, PMI3, PMI4). Based on predetermined criteria and a metric(s) the PMI that has the best metric is selected by PMI processor 125. Using this selected PMI, PMI processor 125 selects the precoding matrix and forwards it to demodulator 127 for demodulation of the precoded data signal.

It should be noted that although four (4) possible PMIs have been used to illustrate the disclosed method, any number of PMIs may be used based on the number of possible states of the feedback signal as defined by system 10. As an example, if system 10 allowed for 10 different states of the feedback signal to be identified, there could be 10 different PMIs in the set that would be used for PMI validation.

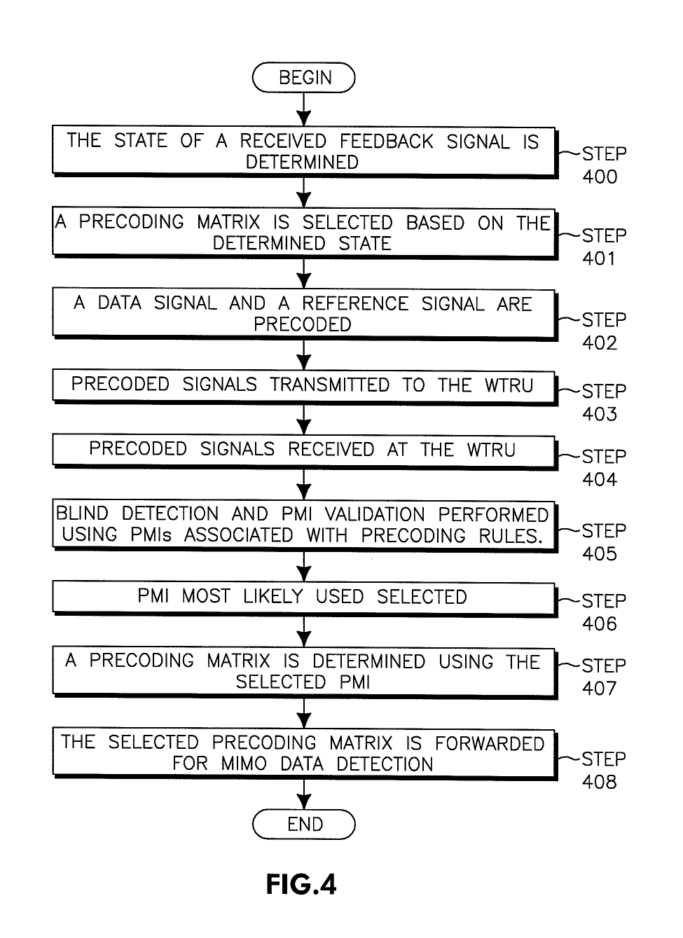

A flow diagram of this alternative method is shown in FIG. 4. eNB 30 detects the state of the feedback signal from WTRU 20 as disclosed above (step 400). Similarly, precoding processor 115 selects the precoding matrix associated with the detected state (step 401). Precoding processor 115, then, precodes the data signal and a reference signal, using the selected precoding matrix (step 402). Both the precoded data signal and the precoded reference signal are forwarded to transmitter 116 for transmission to WTRU 20 (step 403). It should be noted that the reference signal disclosed may be a WTRU specific reference signal or specific to a group of WTRUs.

WTRU 20 receives the precoded data signal and precoded reference signal at receiver 126, and forwards them to PMI processor 125 (step 404). PMI processor 125, then performs blind detection and PMI validation using the possible set of PMIs based on the precoding rules (step 405) and selects the PMI out of the set of possible PMIs that was most likely used PMI by eNB 30 (step 406).

In the example precoding rule set shown in Table 3 below, PMI processor 125 uses the four (4) possible PMIs that are required by the predefined precoding rules, which are the reported PMI, the PMI associated with the previously used precoding matrix, the PMI associated with the default matrix, and the PMI associated with a second default matrix. As those having skill in the art should know, PMI validation may be accomplished in any number ways, for example using hypothesis testing. Typically 16, 32 or more precoding matrices or PMIs may be used for 4×4 multiple input multiple output (MIMO) systems. This requires 16, 32 or more hypotheses for PMI validation which has high complexity. With the disclosed precoding rules (such as precoding rule set A and set B), the number of hypotheses for PMI validation is reduced to 4 from 16, 32 or more. The reduction in the number of hypotheses (or precoding matrices) that are used in the PMI validation reduce the complexity of PMI validation and improves the performance of the PMI validation, since a smaller number of hypotheses for hypothesis testing for the validation processing and blind detection are required.

TABLE 3
(Precoding Rule Set B)

| Feedback | PMI used for precoding |
|---|---|
| Error | matrix |
| No | Reported PMI from WTRU |
| Yes | PMI associated with |
| (previous precoding | previously used precoding |
| matrix is valid) | matrix |
| Yes | PMI associated with a |
| (previous precoding | default precoding matrix |
| matrix not valid) | |
| Feedback Signal | PMI associated with a |
| unreliable | second default precoding |
| | matrix |

Using the selected PMI, PMI processor 125 selects the precoding matrix associated with the selected PMI (step 407) and forwards the selected precoding matrix to demodulator 127, to demodulate the precoded data signal (step 408). As a result of the PMI validation, PMI processor 125 not only is able to determine the appropriate PMI, PMI processor 125 is able to determine the state of the feedback signal. This information may be used for other applications other than PMI validation, for example, uplink power control or adaptive modulation and coding (AMC) for uplink.

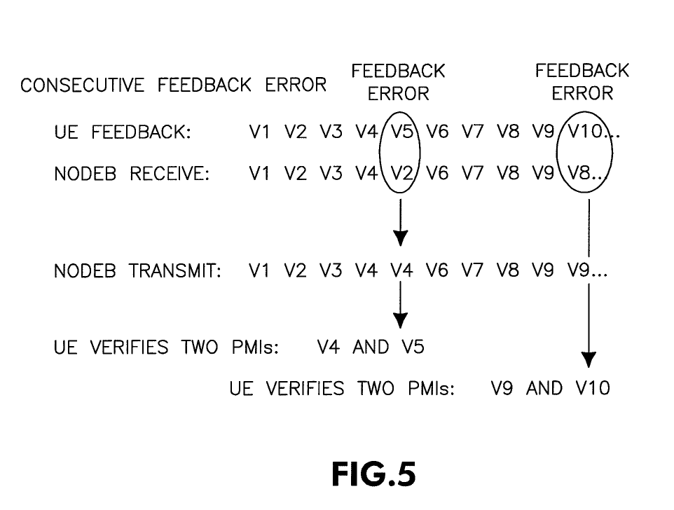

An example of the above method is illustrated in FIG. 5. Referring to FIG. 5, the PMIs fed back from WTRU 20 to eNB 30 are shown, including V1 V2 V3 V4 V5 . . . V10. The PMIs that are received by eNB 30 are shown in the next line, which includes V1 V2 V3 V4 V5 . . . V9 V8. As should be noted in FIG. 5, eNB 30 determines the reliability of the feedback signal and detects an error in the 5^{th} fed back PMI and the 10^{th} fed back PMI, thereby determining that the feedback signal is in state 1 (using the precoding rules stated in Table 4 below).

TABLE 4
(Precoding Rule Set C)

| Feedback | PMI used for precoding |
|---|---|
| Error | matrix |
| No | PMI reported by WTRU |
| Yes | PMI associated with |
| | previously used precoding |
| | matrix |

When eNB 30 determines that the feedback signal is in state 1, eNB 30 selects the PMI associated with the previously used precoding matrix, which is V4 for the 5^{th} fed back PM1 and V9 for the 10^{th} fed back PMI in this example. For the remainder of the PMIs, eNB 30 selects the reported PMI from WTRU 20, since the detected state is for those PMIs is state 0 (i.e., no error detected and deemed reliable by eNB 30). As such, eNB 30 precodes a data block and a dedicated reference signal using the PMIs illustrated in the third line of FIG. 5 (Node B transmit), which includes PMIs V1 V2 V3 V4 V4 . . . V9 V9.

As WTRU 20 receives the precoded reference signal and data blocks, PMI processor 125 validates only the PMIs eNB 30 could have used for precoding, the previously received PMI or the WTRU 20 selected PMI forwarded to eNB 30. As such, when PMI processor 125 validates the 5^{th} received precoded reference signal with PMI embedded in the reference signal (5^{th} received PMI), performing PMI validation on the PMI V4 and PMI V5, PMI V4 will be validated and used to select the precoding matrix used by eNB 30 that is associated with the validated PMI.

Similarly, PMI processor 125 will perform PMI validation on V9 and V10 when it encounters the 10^{th} received PMI. PMI V9 will be validated in this example as a result of the feedback error detected by eNB 30. Therefore, the preceding matrix associated with the validated PMI, PMI V9, will be used for demodulation.

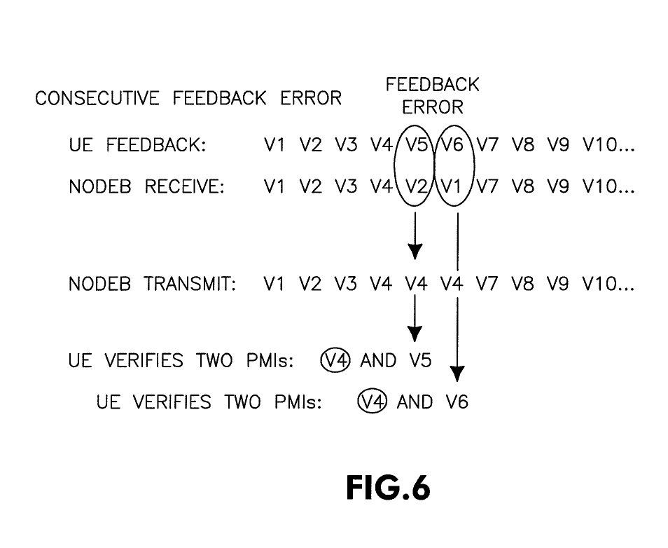

FIG. 6 is another example of this disclosed method. In FIG. 6, eNB 30 will detect that the feedback signal is in state 1 due to the feedback error found at the 5^{th} and 6^{th} fed back PMIs from WTRU 20. As such, eNB 30 selects the PMI associated with the previously used precoding matrix for each of these PMIs based on the predefined precoding rules. In this example, PMI V4 is selected for the 5^{th} PMI. PMI V4 is also selected for the 6^{th} PMI, since PMI V4 is the PMI associated with the previously used reliable precoding matrix.

Accordingly, when WTRU 20 receives the data block from eNB 30, precoding processor 125 performs PMI validation on the previously used PMI and the reported PMI. In accordance with this, for the 5^{th} PMI, preceding processor 125 performs PMI validation using PMI V4 and PMI V5, resulting in the selection of PMI V4. Similarly, for the 6^{th} PMI, PMI processor 125 performs PMI validation using PMI V4 and PMI V6, resulting in the selection of PMI V4.

As those having skill in the art know, orthogonal frequency division multiplexing signals are generally divided into N sub-bands. As such, PMI processor 125 determines a reported PMI for each of the N sub-bands, thereby transmitting to eNB 30 in the feedback signal with N reported PMIs. N may be large for highly frequency selective channel. In accordance with each of the disclosed methods, there are M precoding matrices that are selected by the precoding processor 115, where M can equal any number of matrices between 1 and N. For example, N=25, therefore M may equal any number between 1 and 25. M may also be larger than N if the default precoding matrix is used not per sub-bands but per sub-carrier or a few sub-carriers. M is determined by system 10 and is signaled to WTRU 20 and eNB 30 or M is determined by eNB 30 and is signaled to WTRU 20. The value of M may be based on the state of the feedback signal as determined by precoding processor 115, wherein, using Table 2 above, M=N for state 0, M=1 for state 1, for example. As indicated, M represents the number of precoding matrices that preceding processor 115 uses to precode the N sub-bands. As such, when M=1, the same precoding matrix is used to precode each of the N sub-bands, for example. In the case of M=4, 4 different matrices are used to precode the N sub-bands. In the case of M=N, N precoding matrices are used to precode the N sub-bands, that is, one precoding matrix is used to precode each of the N sub-bands. These N precoding matrices may be different. The value of M can be predetermined (default) or signaled. Which precoding matrix is used for which sub-band can be predetermined (default).

Again, using the example shown in Table 1, Table 5 is an example of this.

TABLE 5
(Precoding Rule Set D)

| | M | Feedback | PMI used for |
|---|---|---|---|
| State | Value | Error | precoding matrix |
| 0 | N | No | PMI(s) selected by |
| | | | WTRU |
| 1 | 1 | Yes | PMI associated with |
| | | | single default matrix |
| | | | or predetermined |
| | | | matrix for all sub- |
| | | | bands |
| 2 | 1 < M <= N | Yes | PMI(s) associated |
| | | | with M default |
| | | | precoding matrices |
| | | | for N sub-bands |

Similar to the methods disclosed above, the default matrices may be a set of default matrices that are each different or the same.

It should be noted that although one precoding rule set is disclosed for each method above, system 10 may include more than one precoding rule set in the signal to WTRU 20 and eNB 30. For example, in Tables 2-5, labeled Rule Sets A-D respectively, system 10 may indicate that Rule Sets A-D are to be stored at WTRU 20 and eNB 30. System 10 may then signal eNB 30 and WTRU 20 using a determined rule signal that identifies which of the Rule Sets are to be used. This allows system 10 the ability to change the precoding rules based on some criteria, such as system conditions or channel conditions. The rule signal may be transmitted in the same signal used by system 10, or selected by eNB 30 and transmitted to WTRU 20 by configuration signaling or higher layer signaling (e.g., layer2/3 signaling), to indicate the precoding rules sets. The configuration signaling or higher layer signaling can be semi-static and are transmitted at a relatively slow rate. An example of this can be shown in Table 6 below.

TABLE 6

| Rule | Precoding |
|---|---|
| Signal | Rule Set |
| 00 | A |
| 01 | B |
| 10 | C |
| 11 | D |

The disclosed methods reduce the complexity or overhead for PMI validation and improve the performance of PMI validation. MIMO precoding performance may also be improved for improved PMI validation.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method for determining a preceding matrix comprising:
determining a state of a feedback signal;
selecting, based on predetermined preceding rules associated with the determined state, a preceding matrix index (PMI); and
determining the precoding matrix using the selected PMI.

2. The method of claim 1, wherein the predetermined precoding rules identify which precoding matrix is used.

3. The method of claim 1, wherein the state of the feedback signal categorizes the reliability of the feedback signal.

4. The method of claim 2, wherein the preceding rules include using a reported PMI when the feedback state of the feedback signal indicates that no error was detected in the feedback signal.

5. The method of claim 4, wherein the preceding rules further includes using a PMI associated with a previously used precoding matrix when the feedback state of the feedback signal indicates that an error was detected.

6. The method of claim 5, wherein the precoding rules further includes using a PMI associated with a default precoding matrix when the feedback state of the feedback signal indicates that the feedback signal is not reliable.

7. The method of claim 6, wherein the default preceding matrix is an identity matrix.

8. The method of claim 2, wherein each of a plurality of precoding rules is associated with at least one of a plurality of feedback states.

9. The method of claim 8, wherein each feedback state is identified by one of each of a plurality of feedback signals, the feedback state signal being a signal included in a control channel.

10. The method of claim 8, further comprising:
receiving the control channel including the feedback state signal that identifies the feedback state of the feedback signal.

11. The method of claim 10, further comprising:
decoding the control channel to detect the feedback state signal; and
associating the selected state signal with the precoding rule.

12. The method of claim 8, further comprising:
receiving a precoding matrix information;
blind detecting the precoded reference signal to detect the precoding information;
performing PMI validation using a set of PMIs associated with the precoding rules; and
using the detected preceding information to determine the most likely used precoding matrix.

13. The method of claim 12, wherein based on the most likely used precoding matrix determining the state of the feedback signal based on the precoding rules.

14. A method for determining a precoding matrix comprising:
decoding a control channel including a feedback state signal to determine a state of a feedback signal;
selecting, based on predetermined preceding rules associated with the determined state, a precoding matrix index (PMI); and
determining the precoding matrix using the selected PMI.

15. The method of claim 14, wherein the predetermined precoding rules identify which precoding matrix is used.

16. The method of claim 14, wherein the state of the feedback signal categorizes the reliability of the feedback signal.

17. The method of claim 15, wherein the precoding rules include using a reported PMI when the feedback state of the feedback signal indicates that no error was detected in the feedback signal.

18. The method of claim 17, wherein the precoding rules further includes using a PMI associated with a previously used precoding matrix when the feedback state of the feedback signal indicates that an error was detected.

19. The method of claim 18, wherein the precoding rules further includes using a PMI associated with a default precoding matrix when the feedback state of the feedback signal indicates that the feedback signal is not reliable.

20. The method of claim 19, wherein the default precoding matrix is an identity matrix.

21. The method of claim 20, wherein each of a plurality of preceding rules is associated with at least one of a plurality of feedback states.

22. The method of claim 21, wherein each feedback state is identified by one of each of a plurality of feedback signals, the feedback state signal being a signal included in a control channel.

23. The method of claim 19, further comprising:
receiving the control channel including the feedback state signal that identifies the feedback state of the feedback signal.

24. The method of claim 20, further comprising:
decoding the control channel to detect the feedback state signal; and
associating the selected state signal with the precoding rule.

25. A method for determining a preceding matrix comprising:
blind detecting a precoded reference signal to determine precoding information;
performing precoding matrix index (PMI) validation using PMIs associated with a predetermined precoding rules and the detected precoding information; and
selecting, based on the PMI validation, the precoding matrix.

26. The method of claim 25, wherein the predetermined precoding rules identify which precoding matrix is used.

27. The method of claim 25, wherein the state of the feedback signal categorizes the reliability of the feedback signal.

28. The method of claim 26, wherein the precoding rules include using a reported PMI when the feedback state of the feedback signal indicates that no error was detected in the feedback signal.

29. The method of claim 28, wherein the precoding rules further includes using a PMI associated with a previously used precoding matrix when the feedback state of the feedback signal indicates that an error was detected.

30. The method of claim 29, wherein the precoding rules further includes using a PMI associated with a default precoding matrix when the feedback state of the feedback signal indicates that the feedback signal is not reliable.

31. The method of claim 30, wherein the default precoding matrix is an identity matrix.

32. The method of claim 31, wherein each of a plurality of precoding rules is associated with at least one of a plurality of feedback states.

33. The method of claim 32, further comprising:
receiving the precoding matrix information; and
using the detected preceding information to determine the most likely used precoding matrix out of the PMIs associated with the precoding rules.

34. The method of claim 33, further comprising, based on the most likely used preceding matrix determining the state of the feedback signal based on the precoding rules.

35. A wireless transmit receive unit (WTRU) for determining a precoding matrix comprising:
a precoding matrix index (PMI) processor for determining a state of a feedback signal to select, based on predetermined precoding rules associated with the determined state, a precoding matrix index (PMI).

36. The WTRU of claim 35, wherein the predetermined precoding rules identify which precoding matrix is used.

37. The WTRU of claim 35, wherein the state of the feedback signal categorizes the reliability of the feedback signal.

38. The WTRU of claim 36, wherein the precoding rules include using a reported PMI when the feedback state of the feedback signal indicates that no error was detected in the feedback signal.

39. The WTRU of claim 38, wherein the preceding rules further includes using a PMI associated with a previously used preceding matrix when the feedback state of the feedback signal indicates that an error was detected.

40. The WTRU of claim 39, wherein the precoding rules further includes using a PMI associated with a default precoding matrix when the feedback state of the feedback signal indicates that the feedback signal is not reliable.

41. The WTRU of claim 40, wherein the default precoding matrix is an identity matrix.

42. The WTRU of claim 41, wherein each of a plurality of precoding rules is associated with at least one of a plurality of feedback states.

43. The WTRU of claim 42, wherein each feedback state is identified by one of each of a plurality of feedback signals, the feedback state signal being a signal included in a control channel.

44. The WTRU of claim 40 further comprises a receiver receiving the control channel including the feedback state signal that identifies the feedback state of the feedback signal.

45. The WTRU of claim 41, wherein the PMI processor decodes the control channel to detect the feedback state signal, the selected feedback state signal is associated with the appropriate precoding rule.

46. The WTRU of claim 42, further comprising:
a receiver for receiving a precoding matrix information;
the PMI processor blind detecting the precoded reference signal to detect the precoding information;
wherein a set of PMIs associated with the preceding rules and the detected precoding information are used for PMI validation.

47. The WTRU of claim 46 wherein a most likely used precoding matrix is determined from the PMI validation.

48. The WTRU of claim 47, wherein based on the most likely used precoding matrix, the state of the feedback signal based on the precoding rules is determined.
